(19) United States
(12) Patent Application Publication
(10) Pub. No.: US 2008/0239405 A1
(43) Pub. Date: Oct. 2, 2008

(54) Double sided fax machine

(76) Inventor: Clarence Thornton, N. Little Rock, AZ (US)

Correspondence Address: Raymond M. Galasso;Galasso & Associates LP, P.O. Box 26503, Austin, TX, 78755-0503, US

(21) Appl. No.: 11/729,138

(22) Filed: Mar. 27, 2007

(51) Int. Cl. H04N 1/00

(52) U.S. Cl. 358/400

(57) ABSTRACT

Double Sided Fax Machine is an improvement on existing facsimile machines that has all of the standard components of a facsimile machine but also has a second group of sensors that permits double-sided transmission and reception. To use Double Sided Fax Machine, an individual inserts sheets of paper into the feed tray. When an incoming facsimile arrives, a sheet of paper is drawn into the housing and text or graphics will be printed on both sides of the piece of paper, depending upon the control buttons pushed by the operator. The paper then exits the facsimile machine via the exit opening on the opposite side of the machine. To send a two-sided transmission, the double sided button is selected and a two-sided document is inserted into the feed tray. The two groups of sensors permit the text and images on both sides of the paper to be scanned and transmitted. The scanned document then passes through the exit opening for retrieval.

### CROSS REFERENCE TO RELATED APPLICATIONS

This United States Non-Provisional Patent Application does not claim priority to any United States Provisional Patent applications or any foreign patent applications.

### FIELD OF THE DISCLOSURE

The disclosures made herein relate generally to the home and office electronics industry. The invention discussed herein is in the general classification of facsimile machines.

### BACKGROUND

Nearly every office in the United States and many homes today have a facsimile (fax) machine. These devices are often connected to a phone line, allowing instant transmission of paper from one office or home to another office or home.

Facsimile machines have been around in one form or another for more than a century. Most of the early designs for facsimile machines involved a rotating drum. To send a fax, a user attached a piece of paper to the drum with the print facing outward. A small photo sensor with a lens and a light was attached to an arm and faced the sheet of paper. The arm would move downward over the sheet of paper from one end to the other as the sheet rotated on the drum. The photo sensor focused in at small spots on the paper that were either black or white. The drum would rotate so that the photo sensor could examine one line of the sheet of paper and then move down a line. To transmit the information through a phone line, early fax machines would designate two tones, one for white and one for black. At the receiving end, a similar rotating-drum mechanism and a pen to mark paper would apply the pen to the paper when it heard the black tone and remove the pen when it heard the white tone.

However, this rotating drum system was too slow for modern day use. Current fax machines have a sensor (actually a group of sensors) to read the paper at the sending end. Usually, the modern fax machine also has a paper-feed mechanism at the sending end to permit multi-page faxes to be sent more easily. There is also a standard way to encode the white and black spots that the fax machine sees on the paper to permit them to travel through the phone line as bits. Often, a compression technique is also utilized to reduce the number of bits representing these encoded spots that needs to be transmitted through the phone line. At the receiving end, the fax machine decodes, decompresses and reassembles the incoming bits into the scanned lines of the original document. The fax is printed onto paper usually in the same manner as with any inkjet or laser printer.

Unfortunately, modern fax machines usually only permit single sided documents to be sent and printed. The inability to send and receive faxes on both sides of a piece of paper creates inefficiency and a waste of paper.

Hence, there is a need in the art for a convenient, inexpensive and effective device for sending and receiving two-sided facsimiles.

### SUMMARY OF THE DISCLOSURE

Double Sided Fax Machine is an improvement on existing facsimile machines that has all of the standard components of a facsimile machine but also has a second group of sensors that permits double-sided transmission and reception.

The principal object of this invention is to provide a device that can print incoming facsimiles on both sides of a piece of paper.

Another object of this invention is to provide a device that can be easily used to send and receive two-sided facsimiles.

Another object of this invention is to provide an affordable device for sending and receiving two-sided facsimiles

Another object of this invention is to provide a device that saves time by sending and receiving two-sided facsimiles.

Yet another object of this invention is to provide a device that conserves paper resources by allowing less paper to be used to send and receive facsimiles.

### BRIEF DESCRIPTION OF THE DRAWINGS

FIG. 1 depicts a perspective view of the preferred embodiment of the present invention.

FIG. 2 depicts a side view of the preferred embodiment of the present invention.

### DETAILED DESCRIPTION OF THE DRAWINGS

The preferred embodiment of is comprised of at least some of the following: a housing, a set of numbered buttons, a set of control buttons, a feed tray and exit opening for paper, gears to draw paper into the housing, two groups of sensors, a processor, an electronic memory, a modem, a liquid crystal display window, a laser printer, a power cord, a connector to a telephone line and a carrying handle.

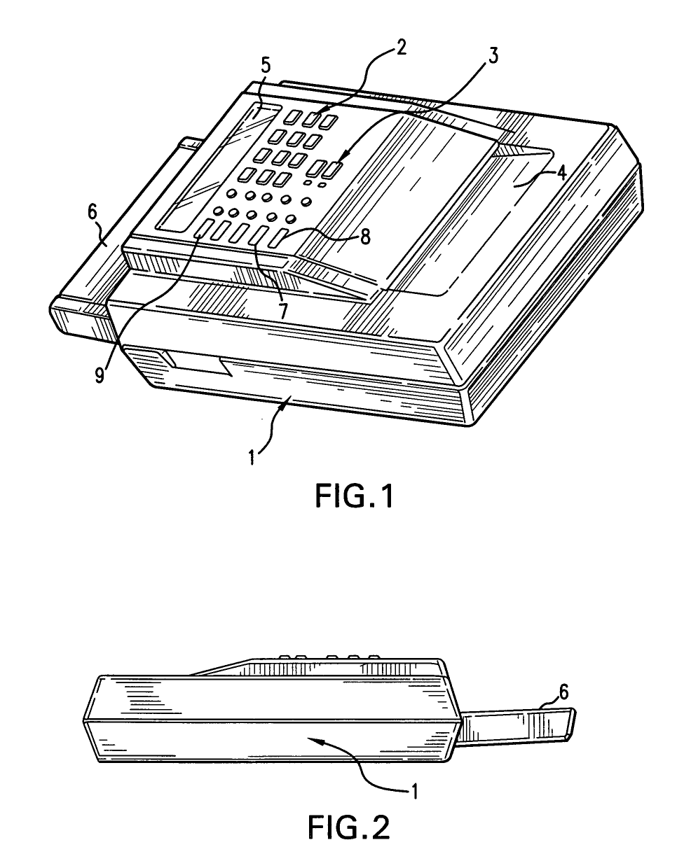

FIG. 1 shows the preferred embodiment of the present invention. As with standard facsimile machines, a housing 1 with a variety of numbered buttons 2 and control buttons 3 covers a processor, modem and an electronic memory. The housing 1 is made of plastic in this preferred embodiment though a variety of materials could be utilized. The housing 1 is eighteen inches in length, twenty-eight inches in width and twelve inches in height. Control buttons 2 include a start button 7 and a stop button 8. A power button 9 is also located on the housing 1. On the top of the housing 1, a feed tray 4 permits paper to enter the housing 1 through the use of gears to grab and pull the paper. A display 5 made of liquid crystal is also located at the top of the housing 1. The housing 1 has a handle 6 at the top with an exit opening for paper located above the handle 6. The housing 1 further has a connector opening for a telephone line and a power cord to supply electricity to the internal components of the housing 1. Inside the housing 1, a laser printer permits the device to print out incoming images or text on a piece of paper.

While standard facsimile machines only have one group of sensors that scan the front of a piece of paper, this facsimile machine has a first and a second group of sensors to permit both the front and back of a piece of paper to be scanned. The first group of sensors (not pictured) is located on the inside and top of the housing while the second group of sensors (not pictured) is located on the inside and bottom of the housing.

FIG. 2 shows a side view of the preferred embodiment of the present invention. The housing 1 and the handle 6 are clearly visible from this angle.

To use Double Sided Fax Machine, an individual inserts sheets of paper into the feed tray. When an incoming facsimile arrives, a sheet of paper is drawn into the housing and text or graphics will be printed on both sides of the piece of paper, depending upon the control buttons pushed by the operator. The paper then exits the facsimile machine via the exit opening on the opposite side of the machine.

To send a two-sided transmission, the two-sided button is selected and a two-sided document is inserted into the feed tray. The two groups of sensors permit the text and images on both sides of the paper to be scanned and transmitted. The scanned document then passes through the exit opening for retrieval.

The materials utilized for Double Sided Fax Machine may vary widely but will likely include metals, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Double Sided Fax Machine can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A data transmission device comprising:
(a) a housing with a set of numbered buttons and a set of control buttons;
(b) a processor, a modem and an internal memory located within the housing;
(c) a display located on the housing; and
(d) a first group of sensors and a second group of sensors within the housing operatively connected to the processor

2. The device of claim 1 wherein the housing is plastic.

3. The device of claim 1 wherein the set of control buttons includes a start button and a stop button.

4. The device of claim 1 further comprising
a power button on the housing.

5. The device of claim 1 further comprising
a feed tray connected to the housing leading to an entrance opening.

6. The device of claim 5 wherein a set of gears are located in the entrance opening.

7. The device of claim 1 wherein the display is made of liquid crystal.

8. The device of claim 1 wherein the housing has a handle.

9. The device of claim 8 wherein the handle is made of plastic and located on the top of the housing.

10. The device of claim 5 wherein an exit opening is located on the housing opposite the entrance opening.

11. The device of claim 1 further comprising
a connector opening on the housing for a telephone line to be connected to the modem.

12. The device of claim 1 further comprising
a power cord protruding through the housing and operatively connected to the processor.

13. The device of claim 1 further comprising
a laser printer contained within the housing.

14. The device of claim 1 further comprising
an inkjet printer contained within the housing.

15. A data transmission device comprising:
(a) a housing made of plastic with a set of numbered buttons and a set of control buttons including a start button and a stop button;
(b) a power button located on the housing;
(c) a processor, an internal memory and a modem located within the housing;
(d) a liquid crystal display located on the housing;
(e) a feed tray connected to the housing leading to an entrance opening;
(f) a set of gears located in the entrance opening;
(g) an exit opening located on the housing opposite the entrance opening;
(h) a first group of sensors and a second group of sensors within the housing and operatively connected to the processor;
(i) a handle made of plastic located on the housing;
(j) a connector opening for a telephone line located on the housing;
(k) a power cord protruding through the housing and operatively connected to the processor; and
(l) a laser printer contained within the housing.
